(19) United States
(12) Patent Application Publication
(10) Pub. No.: US 2008/0314418 A1
(43) Pub. Date: Dec. 25, 2008

(54) Method and System for Furnace Cleaning

(75) Inventors: Xing Zhao, Shanghai (CN); Hai Song, Shanghai (CN); Chunlong Li, Shanghai (CN); Xiaoli Chen, Shanghai (CN)

Correspondence Address: SQUIRE, SANDERS & DEMPSEY L.L.P., 1 MARITIME PLAZA, SUITE 300, SAN FRANCISCO, CA, 94111, US

(73) Assignee: Semiconductor Manufacturing International (Shanghai) Corporation, Shanghai (CN)

(21) Appl. No.: 12/134,441

(22) Filed: Jun. 6, 2008

(30) Foreign Application Priority Data
Jun. 21, 2007 (CN) 200710042340.0

(51) Int. Cl. B08B 3/04

(52) U.S. Cl. 134/36; 134/95.1

(57) ABSTRACT

The present invention provides a method and a system for cleaning furnace, including the steps of introducing a nitrogen gas flow into a cleaning agent tank to carry the cleaning agent, introducing the nitrogen gas carrying the cleaning agent into the furnace via a pipeline to clean the furnace; and generating a steam by mixing and igniting a hydrogen gas flow and an oxygen gas flow, and then introducing the steam into the furnace to clean the furnace. The method for cleaning furnace according to the invention can effectively remove metal and non-metal impurities deposits in a furnace of semiconductor oxidation furnace equipment.

### FIELD OF THE INVENTION

The present invention relates to the technical field of manufacturing a semiconductor, and more particularly, to a method and system for cleaning a furnace in a thermal oxidation furnace equipment.

### DESCRIPTION OF THE RELATED ART

In a semiconductor manufacturing process, a semiconductor element with a particular structure is formed over a semiconductor wafer by performing a plurality of photolithography processes, etching processes, and film forming processes, etc. In the film forming processes, thermal oxidation processes and/or chemical vapor deposition (CVD) processes are generally used for forming various thin films. The thermal oxidation processes principally comprise furnace thermal oxidation process in which reactive gases are introduced into a furnace at a high temperature and then chemically react with a semiconductor wafer in the furnace to deposit a thin film on a surface of the wafer. This furnace thermal oxidation process is used for growing SiO₂, Si₃N₄, SiON or polysilicon, etc. In recent year, this process is also employed for growing metal layers, ferroelectric materials, barrier layers, as well as materials with high or low dielectric constant etc.

Furnace equipments used in the thermal oxidation process generally comprise horizontal type furnaces, vertical type furnaces, barrel type furnaces, etc. For example, a vertical type deposition furnace usually is operated as follows: placing a plurality of wafers in the furnace, feeding a reactive gas such as oxygen gas, nitrogen gas and so on, and growing a dielectric film on a surface of the wafers at a high temperature environment. During this process, some residues of metal ions and polymers may be formed on an inner wall of the furnace. However, With the semiconductor technique reaching a deep-submicron stage, semiconductor device integration level increases greatly, while semiconductor wafer diameter increases from 6˜8 inches to 12 inches. With the increase of wafer diameter, furnace equipments trend to be macro-scale, which means the diameter of furnace increases as well, so that a substantive volume of residues may be formed on the inner wall of the furnace due to the accumulation of metal ions and polymers after the film-forming reaction is performed for several times. If the residues are not removed, they may become a source of particles under heating condition during subsequent processes and then adversely influence the subsequent processes in yield and stability of products.

Chinese patent application No. 03153391.4 discloses a method for cleaning vertical type furnace, in which a sprinkler is employed to spray a cleaning agent on the bottom and top of the furnace, then the cleaning agent flows along the inner wall of the furnace to clean the whole furnace, but the top and bottom of the furnace cannot be cleaned uniformly in the method. FIG. 1 is a schematic view for illustrating another method in the art for cleaning a furnace. As shown in FIG. 1, a nitrogen gas flow 206 is introduced into a cleaning agent tank 202 containing dichloroethylene (Cl₂C₂H₂) as a cleaning agent 204, and then the nitrogen gas flow 206 carries the cleaning agent 204 and enters into the furnace via a line 208 to clean the furnace. Although this method exhibits good effects in removing ions of metals, particularly alkali metals, such as potassium, sodium, etc., it is weak to remove other metal ions and organic polymers, especially in furnace with large diameter and complicate structure, and thus can not achieve an good cleaning effect.

### SUMMARY OF THE INVENTION

One object of the present invention is to provide a method and a system for cleaning a furnace, which can effectively remove metal and non-metal deposits within a furnace of furnace thermal oxidized equipment.

In an aspect, the present invention provides a method for cleaning a furnace, comprising the steps of:
1) cleaning the furnace by using a carrier gas flow carrying a cleaning agent; and
2) cleaning the furnace by using stream.

The step 1) further comprises introducing the carrier gas flow into a cleaning agent tank, and introducing the carrier gas flow carrying the cleaning agent into the furnace via a pipeline to clean the furnace.

The step 2) further comprises generating the steam by mixing and combusting a hydrogen gas flow and an oxygen gas flow, and introducing the steam into the furnace to clean the furnace.

The furnace has an internal temperature of 800° C. to 1200° C. when the furnace is cleaned by using the carrier gas flow carrying the cleaning agent.

The mixing ratio of the hydrogen gas flow to the oxygen gas flow is within the range of critical ratio of explosion of hydrogen and oxygen.

The step 1) can be performed before, during or after the step 2) is performed.

The carrier gas is nitrogen gas.

The cleaning agent is dichloroethylene (Cl₂C₂H₂).

In another aspect, the present invention provides a system for cleaning a furnace, comprising a cleaning agent supplying device and a steam supplying device, wherein the cleaning agent supplying device comprises a carrier gas input line, a cleaning agent tank and a cleaning agent output line, wherein one end of the carrier gas input line connects to a carrier gas source, and its other end is communicated with the cleaning agent tank and extends into the cleaning agent, and one end of the cleaning agent output line connects the cleaning agent tank and its other end is communicated with the furnace to be cleaned; and wherein the steam supply device comprises a combustion chamber and a steam output line, wherein a hydrogen gas flow and an oxygen gas flow are mixed and ignited in the combustion chamber to general a steam, and one end of the steam output line connects the combustion chamber and its other end is communicated with the cleaning agent output line.

The cleaning agent is dichloroethylene (Cl₂C₂H₂).

The carrier gas is nitrogen gas.

The furnace has an internal temperature of 800° C. to 1200° C.

The mixing ratio (volume ratio) of the hydrogen gas flow to the oxygen gas flow is within the critical ratio of explosion of hydrogen and oxygen.

In comparison with the prior art, the present invention has the following advantages: in the embodiments described above, nitrogen gas flow is employed to carry a cleaning agent in order to clean the furnace and a steam is used to clean deposits in the furnace, so that both alkali metal ions and organic polymer residues as well as other metal ions can be effectively removed to achieve good cleaning effect.

### BRIEF DESCRIPTION OF THE DRAWINGS

The above objects, features and advantages of the present invention will become more apparent in view of the following description of the preferred embodiments given in conjunction with the accompanying drawings. In all drawings, same signs represent same parts.

FIG. 1 is a schematic view illustrating a method and equipment for cleaning a furnace according to the prior art.

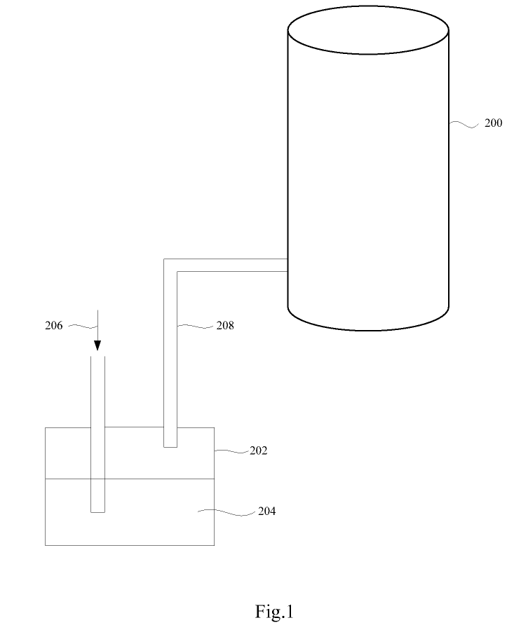

FIG. 2 is a schematic view illustrating a method and equipment for cleaning a furnace according to an example of the present invention.

### SPECIFIC EMBODIMENTS OF THE INVENTION

For further demonstrating the above objects, features and advantages of the present invention, the following description in conjunction with the accompanying drawings is provided for preferred embodiments of the present invention.

The description in detail hereinafter is intended to provide a complete understanding of the present invention. However many other embodiments may be performed by those skilled in the art upon viewing the disclosure herein without departing from the scope and sprit of the appended claims. Thus, the present invention is not intended to be limited by the following embodiments.

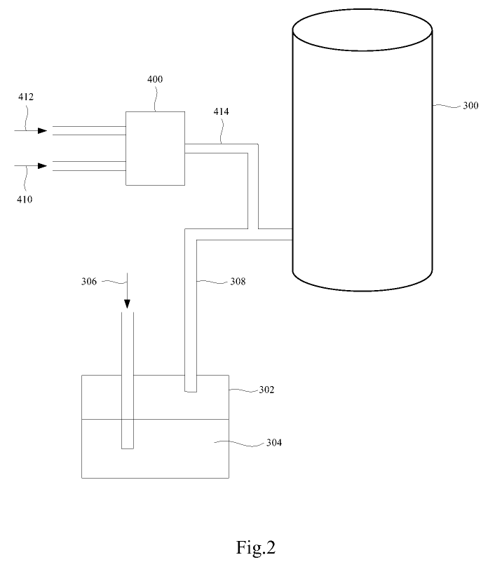

FIG. 2 is a schematic view illustrating a method and equipment for cleaning a furnace according to an embodiment of the present invention. Furnace equipments used in furnace thermal oxidation technology generally comprise, for example, horizontal type furnace equipments, vertical type furnace equipments and barrel type furnace equipments. The preferred embodiments of the present invention are described by taking a vertical type deposition furnace as example, but are not limited to such vertical type furnaces. Under high temperature conditions, some deposits of metal ions and non-metal polymers may form on the inner wall of furnace during a process for growing a dielectric film on a wafer surface in the furnace. With the increase of wafer diameter, furnace diameter increases and furnace equipments trend to be macro-scale and complex accordingly, so that a substantive volume of deposits may form and accumulate on the inner wall of furnace after the film-forming reaction is performed for several times. If these deposits are not removed, they adversely influence the subsequent processes at aspects of yield and stability of products. In the prior art, one of methods for cleaning furnace comprises: introducing into a cleaning agent tank containing dichloroethylene a nitrogen gas flow to carry dichloroethylene into the furnace in order to clean the furnace. However, only ions of alkali metals, such as sodium, potassium, can be removed by such method, and the removal effects for the non-metal polymers are unsatisfactory. In an embodiment of the present invention, a method for cleaning furnace comprises: using a nitrogen gas flow to carry a cleaning agent (such as dichloroethylene in this embodiment) in order to clean the furnace internally, and using a steam flow to clean the furnace internally, so that both alkali metal ions and organic polymer residues as well as other metal ions can be effectively removed so as to achieve better effects of cleaning furnace.

In one embodiment of the present invention as shown in FIG. 2, a nitrogen gas flow 306 is introduced into a cleaning agent tank 302 containing a cleaning agent 304, in which the cleaning agent 304 is preferably dichloroethylene. After the introduction of the nitrogen gas flow 306, it carries the cleaning agent 304 and enters into a furnace 300 via a pipeline 308 to clean the furnace, in which the cleaning is performed for a time period, such as about 30 to 90 minutes, preferably about 1 hour, as determined according to specific conditions. Next, a steam flow is introduced into the furnace to clean the furnace continuously. In the present invention, the steam flow is generally by an unique method comprising introducing a hydrogen gas flow 412 and an oxygen gas flow 410 into a mixing combustion device 400, mixing and igniting the hydrogen gas flow 412 and oxygen gas flow 410 to generate a highly pure steam, and introducing the steam into the furnace 300 via a pipeline 414 so as to clean the furnace 300 internally. The cleaning is also performed for a time period of about 30-90 minutes as determined according to specific conditions. The use of such a highly pure steam exhibits better effect in removal of organic polymer deposits.

In another embodiment of the present invention, a hydrogen gas flow 412 and an oxygen gas flow 410 are firstly introduced into a mixing combustion device 400 in which they are mixed and ignited to generate a highly pure steam, the steam passes through a pipeline 414 and enters into a furnace 300 to clean the furnace 300 internally, and then a nitrogen gas flow 306 is introduced into a cleaning agent tank 302 to carry a cleaning agent 304 into the furnace 300 via a pipeline 308 so as to clean the furnace 300.

In other embodiments of the present invention, the step of cleaning the furnace by using a steam generated by mixing and igniting a hydrogen gas flow 412 and an oxygen gas flow 410 and the step of cleaning the furnace by using a nitrogen gas flow 306 to carry the cleaning agent 304 can be performed simultaneity.

In the above embodiments, when the furnace 300 is cleaned by using a nitrogen gas flow 306 carrying a cleaning agent 304, the internal temperature of the furnace 300 is in a range from 800° C. to 1200° C., and the flow rate of the nitrogen gas flow 306 is 5˜10 ml/s. The mixing ratio of the hydrogen gas flow 412 to the oxygen gas flow 410 in the mixing combustion device 400 is within the range of the critical ratio of explosion of hydrogen and oxygen, and for example, it can be 2.8:3.26.

The present invention further provides a system for cleaning furnace as shown in FIG. 2, which comprises a cleaning agent supplying device and a steam supplying device. The cleaning agent supplying device comprises an input line for a nitrogen gas flow 306, a cleaning agent tank 302, and a cleaning agent output line 308. The steam supplying device comprises a mixing combustion device 400 and a steam output line 414. The cleaning agent tank 302 contains a cleaning agent 304, and the nitrogen gas flow 306 is introduced into the cleaning agent tank 302 to carry the cleaning agent 304 and flows into a furnace 300 via the output line 308 in order to clean the furnace 300 internally. A hydrogen gas flow 412 and an oxygen gas flow 410 are mixed in the mixing combustion chamber 400 and ignited to generate a steam flow, and the steam flow enters into the cleaning agent output line 308 via the steam output line 414 and then was introduced into the furnace 300 so as to clean the furnace 300 internally. The cleaning agent is dichloroethylene (Cl₂C₂H₂), and when the furnace 300 is cleaned by the nitrogen gas flow 306 carrying the cleaning agent 304, the internal temperature of the furnace 300 is 800° C. to 1200° C. and the flow rate of the nitrogen gas flow 306 is 5˜10 ml/s. In the mixing combustion chamber 400, the mixing ratio of the hydrogen gas flow 412 to the oxygen gas flow 410 is 2.8:3.26.

In the present invention, the method for cleaning furnace employs a highly pure deionized steam to clean internal deposits of furnace before, during or after the furnace is cleaned by using a nitrogen gas flow carrying dichloroethylene, so that both alkali metal ions and organic polymer residues as well as other metal ions can be removed. Furthermore, the system for cleaning furnace according to the present invention employs a mixing combustion device in which a hydrogen gas flow and an oxygen gas flow are mixed and ignited to generate a highly pure steam which can be used to achieve better effect of cleaning organic polymer residues.

While the present invention has been described above in conjunction with certain preferred embodiments, these embodiments are not intended to limit the present invention. It will be apparent to those skilled in the art that various changes and modifications of the present invention can be made without departing from the spirit and scope of the invention as defined in the following claims and still fall within the protection scope of the present invention.

What is claimed is:

1. A method for cleaning a furnace, comprising the steps of:
1) cleaning the furnace by using a carrier gas flow carrying a cleaning agent; and
2) cleaning the furnace by using stream.

2. The method according to claim 1, wherein the step 1) comprises introducing the carrier gas flow into a cleaning agent tank, and introducing the carrier gas flow carrying the cleaning agent into the furnace via a pipeline to clean the furnace.

3. The method according to claim 1, wherein The step 2) comprises generating the steam by mixing and combusting a hydrogen gas flow and an oxygen gas flow, and introducing the steam into the furnace to clean the furnace.

4. The method according to claim 1, wherein the carrier gas is nitrogen gas.

5. The method according to claim 1, wherein the cleaning agent is dichloroethylene (Cl₂C₂H₂).

6. The method according to claim 1, wherein the furnace has an internal temperature of 800° C. to 1200° C. when the furnace is cleaned by using the carrier gas flow carrying the cleaning agent.

7. The method according to claim 1, wherein the mixing ratio of the hydrogen gas flow to the oxygen gas flow is within the range of critical ratio of explosion of hydrogen and oxygen.

8. The method according to claim 1, wherein the step 1) is performed before, during or after the step 2) is performed.

9. A system for cleaning a furnace, comprising a cleaning agent supplying device and a steam supplying device, wherein the cleaning agent supplying device comprises a carrier gas input line, a cleaning agent tank and a cleaning agent output line, wherein one end of the carrier gas input line connects to a carrier gas source, and its other end is communicated with the cleaning agent tank and extends into the cleaning agent, and one end of the cleaning agent output line connects the cleaning agent tank and its other end enters into the furnace to be cleaned; and wherein the steam supply device comprises a combustion chamber and a steam output line, wherein a hydrogen gas flow and an oxygen gas flow are mixed and ignited in the combustion chamber to general a steam, and one end of the steam output line connects the combustion chamber and its other end is communicated with the cleaning agent output line.

10. The system for cleaning a furnace according to claim 9, wherein the cleaning agent is dichloroethylene (Cl₂C₂H₂).

11. The system for cleaning a furnace according to claim 9, wherein the carrier gas is nitrogen gas.

12. The system for cleaning a furnace according to claim 9, wherein the furnace has an internal temperature of 800° C. to 1200° C.

13. The system for cleaning a furnace according to claim 9, wherein the mixing ratio of the hydrogen gas flow to the oxygen gas flow is within the critical ratio of explosion of hydrogen and oxygen.
